(19) United States
(12) Patent Application Publication
(10) Pub. No.: US 2010/0132143 A1
(43) Pub. Date: Jun. 3, 2010

(54) PLUMBING SNAKE AND ENGAGEMENT HEAD THEREFOR

(76) Inventor: Robert Flamand, Saskatoon (CA)

Correspondence Address: ADE & COMPANY INC., 2157 Henderson Highway, WINNIPEG, MB, R2G1P9, CA

(21) Appl. No.: 12/325,318

(22) Filed: Dec. 1, 2008

(51) Int. Cl. B08B 9/02

(52) U.S. Cl. 15/104.33

(57) ABSTRACT

The present invention provides a high powered magnetic tipped toilet auger with several hooking barbs located on the back side of the magnetic tip to remove obstructions from plugged toilets especially if the obstruction is a ferrous metal material or consists of a hookable or snagable material. The magnetic tip can be quickly and easily be attached to an existing toilet auger.

This invention relates to plumbing took for insertion of a flexible wire into a drain pipe for extraction of any blocking materials.

### BACKGROUND OF THE INVENTION

Toilet bowl drain pipe solid obstructions occur most often when children purposely or other careless persons accidentally flush countless types of items down the toilet. Although accidental solid obstruction can occur when different bathroom related items accidentally fall into the toilet bowl from counter tops, toilet tank tops and shelving located above the toilet bowl and get flushed accidentally.

The commonly used toilet augers provide a cork screw type tip that can drill through a soft toilet paper based obstruction but has little to no capability of removing solid obstructions from the toilet bowl drain. In most cases the toilet has to be loosened, unsealed then lifted off the floor and drain mount allowing for the manual removal of the solid obstruction through the bottom access to the toilet bowl drain. Most home owners are technically incapable to complete this procedure and most plumbers dislike removing the toilet from its base.

### SUMMARY OF THE INVENTION

It is one object of the present invention to provide an improved device of this type for removing objects from a toilet drain.

According to a first aspect of the invention there is provided a tool for removing articles from a toilet drain comprising:

a flexible wire member;

a rotating drive member at a rear end of the wire member for rotating the wire member around its longitudinal axis;

such that the wire member can be driven by longitudinal force and rotation into a drain pipe for engaging a blockage material in the drain pipe;

and a magnet carried on a mounting member attached to a forward end of the wire member.

Preferably the mounting member has a front face facing forwardly of the wire member along the axis with the magnet mounted thereon and a rear mounting portion for engaging the wire member.

Preferably the rear mounting portion for engaging the wire member comprises a threaded screw for engaging into a hollow interior of the wire member.

Preferably the wire member comprises a wire wrapped around an axis of the wire member to form a helix so as to define a hollow interior within the helix.

Preferably the rear mounting portion comprises a threaded screw for engaging into a hollow interior of the wire member and a nut having a threaded nut portion and a side projecting portion for holding within the hollow interior of the wire.

Preferably the wire member is partly opened at the front end to form an open helix.

Preferably the mounting portion comprises a rearwardly extending rod portion for engaging into the hollow interior of the helix.

Preferably the rod portion has radially projecting engagement members thereon and is attached to the wire member by the engagement members and by an adhesive.

Preferably the radially projecting engagement members form a male threaded portion of the rod portion.

Preferably the mounting member includes a plurality of rearwardly projecting spikes for snagging fabric materials.

In one arrangement the projecting spikes are carried on a spiked disk which is mounted behind the magnet.

In another arrangement the mounting member comprises an injection molded body having a front receptacle for carrying the magnet and the rear projecting spikes connected to and extending rearwardly from the receptacle.

Preferably the mounting member is circular in front elevation.

Preferably the magnet is a disk and the mounting member includes an embedded ferrous metal disk behind and parallel to the magnet.

Preferably the spikes lie in a cylindrical wall at an outer edge of the mounting member.

Preferably the spikes are tapered angularly and radially to form a sharp apex at an outer cylindrical surface of the mounting member.

According to a second aspect of the invention there is provided an engagement head for mounting on a tool for removing articles from a toilet drain comprising a flexible wire member with a rotating drive member at a rear end of the wire member for rotating the wire member around its longitudinal axis such that the wire member can be driven by longitudinal force and rotation into a drain pipe for engaging a blockage material in the drain pipe, the engagement head comprising:

a body having a front face facing forwardly of the wire member along the axis and a rear mounting portion for engaging the wire member;

the body having a front receptacle and a rearwardly projecting spikes connected to and extending rearwardly from the receptacle

and a magnet carried in the receptacle.

Preferably the rear mounting portion for engaging the wire member comprises a threaded screw.

Preferably the body is an integral injection molded member including the front receptacle and the rear projecting spikes.

Preferably the body is circular in front elevation.

Preferably the magnet is a disk and the body includes an embedded ferrous metal disk behind and parallel to the magnet.

Preferably the spikes lie in a cylindrical wall at an outer edge of the body.

Preferably the spikes are tapered angularly and radially to form a sharp apex at an outer cylindrical surface of the body.

The device allows the purchasing consumer or professional a dramatic increase in the odds of removing a solid obstruction from a toilet bowl drain because of the high powered magnetic tip with a barbed rear side. It is a well known fact that children flush knifes, forks, and spoons down toilets. The high powered magnetic tipped toilet auger can easily attract and pull these metal obstructions from a toilet bowl drain. Socks and facial clothes are also a common solid obstruction of which the barbed backside of the high powered magnetic tip can easily and quickly snag and grip these cloth obstructions and remove them from the toilet bowl drain pipe.

### BRIEF DESCRIPTION OF THE DRAWINGS

FIG. 1 is a side elevational view of an engagement head of a tool according to the invention with a barbed magnetic assembly attachment for mounting on a toilet auger shown in FIG. 5.

FIG. 2 is a cross sectional view of the engagement head of FIG. 1.

FIG. 3 is an isometric view from the rear of the engagement head of FIG. 1.

FIG. 4 is an isometric view from the front and one side of the engagement head of FIG. 1.

FIG. 5 is an exploded side elevational view of the toilet auger including the engagement head of FIG. 1.

FIG. 6 is a side elevational view of the toilet auger including the engagement head of FIG. 1.

FIG. 7 is an exploded side elevational view of an alternative arrangement of the engagement head including the toilet auger.

FIG. 7A is a side elevational view of the alternative arrangement of FIG. 7 including the toilet auger.

FIG. 8 is an exploded view of the engagement head of FIG. 1.

### DETAILED DESCRIPTION

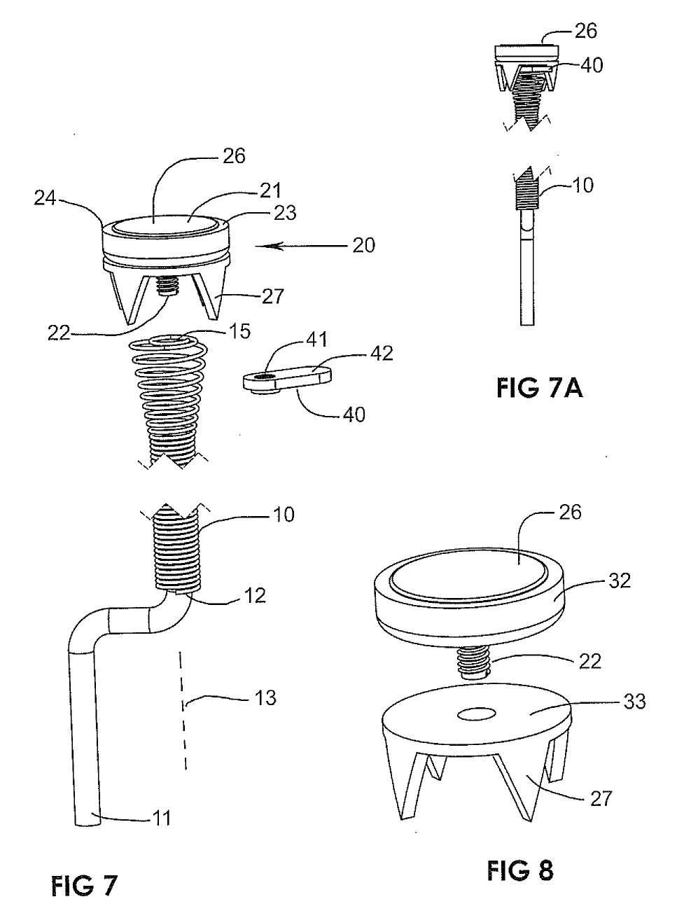

The toilet auger shown in FIG. 7 herein for removing articles from a toilet drain includes a flexible wire member 10 with a rotating drive member 11 at a rear end 12 of the wire member for rotating the wire member around its longitudinal axis 13 such that the wire member can be driven by longitudinal force and rotation into a drain pipe for engaging a blockage material in the drain pipe.

An engagement head for mounting on the forward end 15 of the auger includes a body 20 having a front face 21 facing forwardly of the wire member along the axis 13 and a rear mounting portion 22 for engaging the wire member.

The body has a front receptacle 23 defined by a peripheral circular wall 24 with a central area 25 recessed from the wall to receive a disk shaped circular magnet 26 carried in the receptacle so that the body is circular in front elevation.

The body has a series of rearwardly projecting spikes 27 connected to and extending rearwardly from the outer wall of the receptacle.

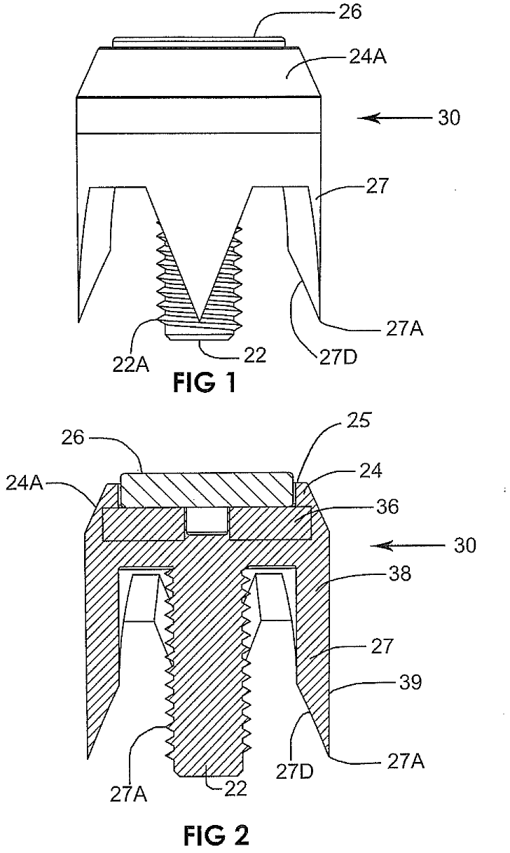

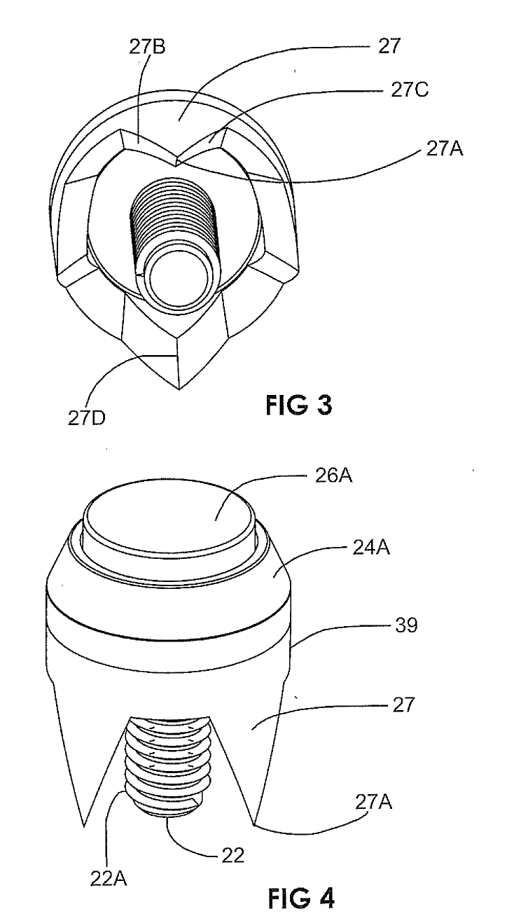

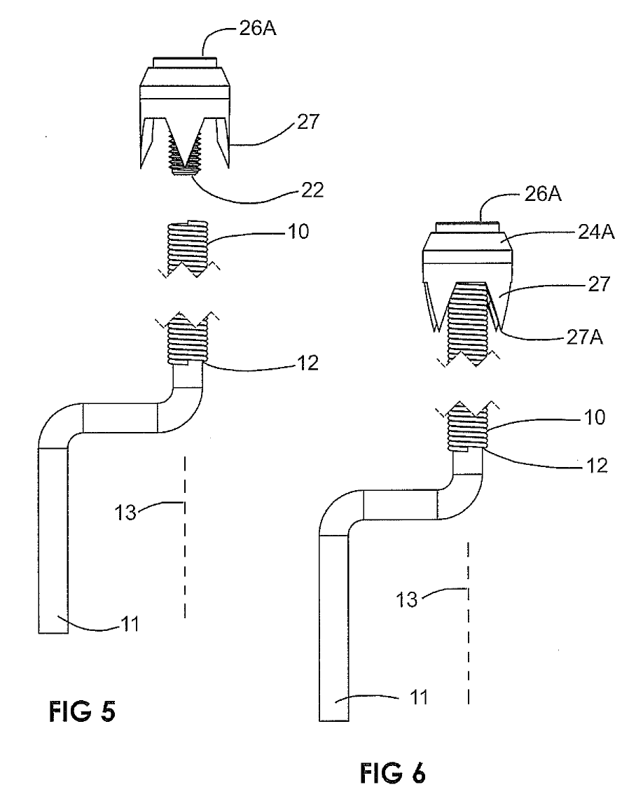

In FIGS. 1 to 4, the body is an integral injection molded member 30 including the front receptacle and the rear projecting spikes.

In FIGS. 7 and 8 the body is formed in two pieces including a front disk 32 and a rear disk 33 arranged back to back with the edge of the rear disk 33 carrying the spikes.

The body includes an embedded ferrous metal disk 36 behind and parallel to the magnet disk 26 and 26A with both being circular in plan.

The spikes 27 lie in a cylindrical wall 38 at an outer edge of the body and extending rearwardly from the wall 24. The wall 24 has a tapered shape 24A so that it decreases in diameter toward the front so as to slide easily along the pipe to be cleared.

The spikes or barbs 27 are tapered both angularly and radially to form a sharp apex 27A at the outer cylindrical surface 39 of the body. Thus the angular tapered shape defines side surfaces 27B and 27C and the radial tapered shape defines an inner surface 27D.

The rear mounting portion 22 for engaging the wire member comprises a threaded screw 22A for engaging into a hollow interior of the wire member which comprises a wire wrapped around an axis of the wire member to form a helix so as to define a hollow interior within the helix.

The threaded screw for engaging into a hollow interior of the wire member has in the arrangement shown in FIG. 7 a nut 40 having a threaded nut portion 41 and a side projecting portion 42 for holding within the hollow interior of the wire. In this arrangement, the wire member is partly opened at the front end to form an open helix 15 allowing the flat nut to be inserted between two turns of the wire.

In the arrangement of FIGS. 1 to 4, the rod portion has the threads or other radially projecting engagement members thereon and is attached to the wire member by the engagement members and by an adhesive. The rod portion 22 is part of the injection molding and thus formed in plastic.

Thus FIGS. 1 to 4 show the plastic injection molded magnet cup with four barbs protruding out from the bottom outer edge. The molded magnet cup has the thick ferrous metal disc or washer 36 molded into its structure during the plastic injection process. This thick ferrous metal disc almost doubles the pull force of the magnet by directing the magnetic flux upward away from ferrous disc and through the top of the magnet. The thick ferrous disc also acts as an adhesive surface for gluing the magnet into place as well the magnet is held in place via the magnetic pull force toward the thick ferrous metal disc. The magnet is of neodymium magnet material which is the most powerful magnetic materials available. The magnet 26 is completely coated in a thin layer of plastic or rubber coating which protects the magnet for unnecessary chipping and cracking allowing for further protrusion of the magnet from the plastic magnet cup. This allows for a magnet side wall attraction of ferrous toilet drain obstructions. The barbs are shaped in such a fashion as to create a V-shaped point from three directions to allow for a squeeze and snag action from three different angles. The outside dimension of the plastic threaded post is slightly larger than the inside dimension of the spring steel toilet auger. This allows the plastic threaded post to be screwed into the helix of the toilet auger creating a tight friction and threaded fit that is also glued for a long term connection. The plastic injected wall surrounding the bottom edge of the magnet is purposely angled at 24A to allow a beveling action into tight places.

In FIGS. 1, 2, 7 and 8 the high powered neodymium magnet 26 does not have a plastic or rubber coating so therefore the magnet is low profile to protect the magnet from striking against the inside of the toilet bowl drain that may cause chipping and cracking while in use.

The thick ferrous metal disc or washer 36 has a center hole which is required to facilitate mounting of the ferrous washer into the plastic injection molding device. A two part steel welding adhesive is used specially formulated for bonding metal to metal and plastic to metal. This adhesive does not interfere with the magnetic flux transfer from ferrous metal disc and magnet. The injection molding process the highest grade of nylon plastic to create the hardest, non-breaking, non-bending magnetic assembly possible.

The pot magnet assembly could include more than four barbs creating more snagging points. The threaded post 22 has a slightly greater outside dimension than the spring steel toilet auger has for an inside dimension. This causes a very tight locking fit when threaded post is screwed into spring steel toilet auger. What also occurs, when the threaded post enters the toilet auger, is that the spring steel is forced and flexes into a slightly greater inside dimension which creates a locking force between the threaded post and the inside of the toilet auger. This locking or holding force is partially created by the way the tip of the toilet auger 10 is formed to create a flat surface and inner flat edge as well as a beveled edge which also has an inner flat surface. This creates a female single thread flow pattern of which the threaded post can be threaded into thus allowing the threaded post to be screwed into the center hole of the toilet auger being forced, held and locked into place.

The plastic molded magnet cup assembly ensures the magnetic force of the disc magnet pulls from the open face of magnet only. No magnetic power is lost in any other direction. The magnet 26, 26A is glued into place within the plastic cup assembly with adhesive.

The preferred plastic material is nylon, it has small fibers within its structure which creates a stronger plastic. Nylon material will make the barbs less likely to bend or break when snagging and removing a solid obstruction from a toilet bowl drain.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A tool for removing articles from a toilet drain comprising:
a flexible wire member;
a rotating drive member at a rear end of the wire member for rotating the wire member around its longitudinal axis;
such that the wire member can be driven by longitudinal force and rotation into a drain pipe for engaging a blockage material in the drain pipe;
and a magnet carried on a mounting member attached to a forward end of the wire member.

2. The tool according to claim 1 wherein the mounting member has a front face facing forwardly of the wire member along the axis with the magnet mounted thereon and a rear mounting portion for engaging the wire member.

3. The tool according to claim 2 wherein the rear mounting portion for engaging the wire member comprises a threaded screw for engaging into a hollow interior of the wire member.

4. The tool according to claim 2 wherein the wire member comprises a wire wrapped around an axis of the wire member to form a helix so as to define a hollow interior within the helix.

5. The tool according to claim 4 wherein the rear mounting portion comprises a threaded screw for engaging into a hollow interior of the wire member and a nut having a threaded nut portion and a side projecting portion for holding within the hollow interior of the wire.

6. The tool according to claim 5 wherein the wire member is partly opened at the front end to form an open helix.

7. The tool according to claim 4 wherein the mounting portion comprises a rearwardly extending rod portion for engaging into the hollow interior of the helix.

8. The tool according to claim 7 wherein the rod portion has radially projecting engagement members thereon and is attached to the wire member by the engagement members and by an adhesive.

9. The tool according to claim 8 wherein the radially projecting engagement members form a male threaded portion of the rod portion.

10. The tool according to claim 1 wherein the mounting member includes a plurality of rearwardly projecting spikes for snagging fabric materials.

11. The tool according to claim 10 wherein the projecting spikes are carried on a spiked disk which is mounted behind the magnet.

12. The tool according to claim 10 wherein the mounting member comprises an injection molded body having a front receptacle for carrying the magnet and the rear projecting spikes connected to and extending rearwardly from the receptacle.

13. The tool according to claim 12 wherein the mounting member is circular in front elevation.

14. The tool according to claim 12 wherein the magnet is a disk and the mounting member includes an embedded metal disk behind and parallel to the magnet.

15. The tool according to claim 12 wherein the spikes lie in a cylindrical wall at an outer edge of the mounting member.

16. The tool according to claim 15 wherein the spikes are tapered angularly and radially to form a sharp apex at an outer cylindrical surface of the mounting member so as to allow the spikes to jamb and lock solid obstructions for them to be removed.

17. The tool according to claim 1 wherein the magnet includes a protective coating.

18. The tool according to claim 1 wherein a front face of the mounting member is tapered on side edges thereof to allow the mounting member with the magnet thereon to be pushed forwardly into restricted areas.

19. An engagement head for mounting on a tool for removing articles from a toilet drain comprising a flexible wire member with a rotating drive member at a rear end of the wire member for rotating the wire member around its longitudinal axis such that the wire member can be driven by longitudinal force and rotation into a drain pipe for engaging a blockage material in the drain pipe, the engagement head comprising:
a body having a front face facing forwardly of the wire member along the axis and a rear mounting portion for engaging the wire member;
the body having a front receptacle and a rearwardly projecting spikes connected to and extending rearwardly from the receptacle
and a magnet carried in the receptacle.

20. The engagement head according to claim 19 wherein the body is an integral injection molded member including the front receptacle and the rear projecting spikes.
